(19) United States
(12) Patent Application Publication
(10) Pub. No.: US 2008/0117064 A1
(43) Pub. Date: May 22, 2008

(54) FIRE DETECTOR HAVING A LIFTING FUNCTION

(76) Inventor: Jeong-Hun SHIN, Suncheon-si (KR)

Correspondence Address: VOLPE AND KOENIG, P.C., UNITED PLAZA, SUITE 1600, 30 SOUTH 17TH STREET, PHILADELPHIA, PA, 19103, US

(21) Appl. No.: 12/022,747

(22) Filed: Jan. 30, 2008

Related U.S. Application Data
(63) Continuation-in-part of application No. PCT/KR2007/003187, filed on Jun. 29, 2007.

(30) Foreign Application Priority Data
Jun. 29, 2006 (KR) 1020060059058
Jun. 29, 2006 (KR) 1020060059060
Apr. 30, 2007 (KR) 1020070041751
Jun. 28, 2007 (KR) 1020070064116

(51) Int. Cl. G08B 17/12

(52) U.S. Cl. 340/577

(57) ABSTRACT

A fire detector having a lifting function includes a fixed body fixed to a ceiling of a building, a lifting reel installed to the fixed body to vertically move a wire below the fixed body, and a fire detection unit connected to the wire below the lifting reel and installed to be vertically movable by the lifting reel. The lifting reel includes a drum connected with the wire to wind or unwind the wire by a motor, a lifting body positioned at a lower end of the fixed body and connected with the wire, and a contact terminal formed at an upper end of the lifting body. The contact terminal of the lifting body is contacted with a contact terminal formed at a lower end of the fixed body when the lifting body is completely ascended. The fire detection unit is fixed to the lifting body.

### BACKGROUND OF THE INVENTION

1. Field of the Invention

The present invention relates to a fire detector having a lifting function, and more particularly to a fire detector installed to a ceiling of a building to be vertically movable using a separate lifting reel when requiring cleaning or exchange of parts.

2. Description of the Related Art

Generally, it is regulated under the low that a fire detector should be installed in a building over a certain size. The fire detector is generally installed at a position within 30 cm from the ceiling when a building is newly built. This fire detector detects a fire at an early stage and thus helps to reduce damages of lives and fortunes.

Generally, a fire detector is fixed to the ceiling when a building is newly constructed. Thus, the fire detector is substantially not exchanged or maintained before the building is aged and thus re-constructed or renovated. In this reason, most fire detectors installed to the ceiling of aged buildings are not normally operated since they are over the life cycle or not maintained.

If a fire occurs, the fire detector detects the fire or smoke, and then operates a spring cooler to extinguish the fire. However, if the spring cooler is not operated due to the breakdown of a not-maintained fire detector, even a small fire is worsen into a great fire, thereby causing enormous life and fortune damages.

### SUMMARY OF THE INVENTION

The present invention is designed in consideration of the above problems, and therefore it is an object of the invention to provide a fire detector having a lifting function, including a lifting reel separately installed to a fire detection unit installed to a ceiling of a building to detect a fire such that the fire detection unit is descended to the ground using the lifting reel and then periodically or frequently repaired or exchanged in a safe way when the fire detection unit is broken down.

Another object of the present invention is to provide a fire detector having a lifting function, which also has a crime prevention function by forming a human detection sensor to a lower end of a fixed body and then detecting an alien person illegally invading into the building, and then informing a user of the fact in an audible or visible way or using a wire/wireless terminal.

Still another object of the present invention is to provide a fire detector having a lifting function, which ensures the fire detection unit to be always supplied with power by continuously keeping a contact status between contact terminals used for supplying power to the fire detection unit through a certain procedure though the contact status between the contact terminals are loosed.

Further another object of the present invention is to provide a fire detector having a lifting function, which includes an LED in a lifting body such that a user may check through the LED by naked eyes whether power is supplied to the fire detection unit.

Still further another object of the present invention is to provide a fire detector having a lifting function, which includes contact terminals respectively formed at a lower end of a fixed body having a lifting reel used for lifting the fire detection unit and an upper end of the lifting body, the contact terminals being composed of an inner circular terminal and an outer circular terminal having a ring shape with a certain area, whereby, when the fire detection unit is coupled with the lifting reel, the lower end of the fixed body and the upper end of the lifting body are surface-contacted and also ensure accurate electric contact between them by means of the inner circular terminal and the outer circular terminal though the fire detection unit is moving.

Another object of the present invention is to provide a fire detector in which a plurality of guide rolls are provided in the lifting reel such that the wire may be uniformly wound around the entire outer circumference of a drum.

In order to accomplish the above object, the present invention provides a fire detector having a lifting function, comprising: a fixed body fixed to a ceiling of a building; a lifting reel installed to the fixed body to vertically move a wire below the fixed body; and a fire detection unit connected to the wire below the lifting reel and installed to be vertically movable by the lifting reel.

Preferably, the lifting reel includes a drum connected with one end of the wire and capable of winding or unwinding the wire by a motor; a lifting body positioned at a lower end of the fixed body and connected with the other end of the wire; and a contact terminal formed at an upper end of the lifting body, wherein the contact terminal of the lifting body is contacted with a contact terminal formed at a lower end of the fixed body when the lifting body is completely ascended, wherein the fire detection unit is fixed to a lower portion of the lifting body.

Also preferably, a socket is formed at a lower end of the lifting body, and the fire detection unit is electrically connected to the contact terminal of the lifting body through the socket when being fixed to the lifting body.

In another aspect of the present invention, the fire detector having a lifting function according to the present invention may further include a crime prevention unit installed to the fixed body to detect an alien person illegally invading the building and informing a user of the fact.

Preferably, the crime prevention unit includes a human detection sensor installed to a lower end of the fixed body to detect an alien person illegally invading the building; an emergency bell for generating an alarm to give an audible warning to a user in case the human detection sensor detects an alien person illegally invading the building; a lamp repeatedly turned on and off to give a visible warning to a user in case the human detection sensor detects an alien person illegally invading the building; and a communication unit for sending a warning message to a phone number set by a user using a wire/wireless communication network in case the human detection sensor detects an alien person illegally invading the building.

Also, the crime prevention unit may further include a remote controller for wirelessly manipulating all or some components of the crime prevention unit; and a pilot lamp used for checking from outside that the crime prevention unit is converted into a crime prevention mode by the remote controller.

In still another aspect of the present invention, it is preferred that a fixed plate is installed on the contact terminal of the fixed body, and a spring is installed between the contact terminal of the fixed body and the fixed plate to elastically press the contact terminal of the fixed body downward.

Also preferably, the fire detector of the resent invention further includes a detection sensor installed adjacent to the contact terminal of the fixed body to detect a contact status between the contact terminal of the fixed body and the contact terminal of the lifting body, wherein, while the lifting body is ascended and contacted with the fixed body, in case the contact status between the contact terminal of the fixed body and the contact terminal of the lifting body is loosed, the motor is driven to additionally ascend the lifting body.

At this time, the fire detector of the present invention may further include an LED (Light Emitting Diode) installed to the lifting body in connection with the contact terminal of the lifting body, wherein the LED is turned on when power is applied to the fire detection unit, thereby visibly displaying to outside whether the fire detection unit is operating.

In further another aspect of the present invention, it is possible that the contact terminal of the fixed body is composed of an outer circular terminal and an inner circular terminal, which have concentric shapes with predetermined areas, and the contact terminal of the lifting body is composed of an outer circular terminal and an inner circular terminal, which have concentric shapes with predetermined areas and are disposed in the same diameter as the contact terminal of the fixed body.

As an alternative, it is also possible that the contact terminal of the fixed body is composed of an outer circular terminal and an inner circular terminal, which have concentric shapes with predetermined areas, and the contact terminal of the lifting body is composed of an outer circular terminal disposed in the same diameter as the outer circular terminal of the contact terminal of the fixed body having a predetermined area and a small inner terminal disposed in the same diameter as the inner circular terminal of the fixed body.

As another alternative, it is also possible that the contact terminal of the fixed body is composed of an outer circular terminal and an inner circular terminal, which have concentric shapes with predetermined areas, and the contact terminal of the lifting body is composed of a small outer terminal disposed in the same diameter as the outer circular terminal of the contact terminal of the fixed body and an inner circular terminal disposed in the same diameter as the inner circular terminal of the fixed body and having a predetermined area.

As still another alternative, it is also possible that the contact terminal of the fixed body is composed of an outer circular terminal and an inner circular terminal, which have concentric shapes with predetermined areas, and the contact terminal of the lifting body is composed of a small outer terminal disposed in the same diameter as the outer circular terminal of the contact terminal of the fixed body and a small inner terminal disposed in the same diameter as the inner circular terminal of the fixed body.

Meanwhile, it is also possible that the contact terminal of the lifting body is composed of an outer circular terminal and an inner circular terminal, which have concentric shapes with predetermined areas, and the contact terminal of the fixed body is composed of an outer circular terminal disposed in the same diameter as the outer circular terminal of the contact terminal of the lifting body having a predetermined area and a small inner terminal disposed in the same diameter as the inner circular terminal of the lifting body.

As another alternative, it is also possible that the contact terminal of the lifting body is composed of an outer circular terminal and an inner circular terminal, which have concentric shapes with predetermined areas, and the contact terminal of the fixed body is composed of a small outer terminal disposed in the same diameter as the outer circular terminal of the contact terminal of the lifting body and an inner circular terminal disposed in the same diameter as the inner circular terminal of the lifting body and having a predetermined area.

As still another alternative, it is also possible that the contact terminal of the lifting body is composed of an outer circular terminal and an inner circular terminal, which have concentric shapes with predetermined areas, and the contact terminal of the fixed body is composed of a small outer terminal disposed in the same diameter as the outer circular terminal of the contact terminal of the lifting body and a small inner terminal disposed in the same diameter as the inner circular terminal of the lifting body.

Meanwhile, it is also possible that the contact terminal of the fixed body is composed of an outer circular terminal disposed in a predetermined diameter and having a predetermined area and a small inner terminal disposed in the outer circular terminal, and the contact terminal of the lifting body is composed of a small outer terminal disposed in the same diameter as the outer circular terminal of the contact terminal of the fixed body and an inner circular terminal disposed in the same diameter as the small inner terminal of the fixed body and having a predetermined area.

As another alternative, it is also possible that the contact terminal of the lifting body is composed of an outer circular terminal disposed in a predetermined diameter and having a predetermined area and a small inner terminal disposed in the outer circular terminal, and the contact terminal of the fixed body is composed of a small outer terminal disposed in the same diameter as the outer circular terminal of the contact terminal of the lifting body and an inner circular terminal disposed in the same diameter as the small inner terminal of the lifting body and having a predetermined area.

In another aspect of the present invention, there is also provided a fire detector, wherein the lifting reel includes a drum rotated by a motor in a clockwise/counterclockwise direction; a wire connected to the fire detection unit with one end being fixed to the drum so as to be wound or unwound around the drum; a fixed roll spaced apart from the drum by a predetermined distance and rotated on a fixed roll shaft to guide the wire while the wire taken-up around the drum is wound or unwound; and at least two guide rolls arranged between the drum and the fixed roll to guide the wire, wherein the at least two guide rolls guide the wire substantially perpendicular to the drum while the wire is wound around the drum.

Preferably, two or three guide rolls are arranged between the drum and the fixed roll, and the guide rolls are rotatably coupled to guide roll shafts respectively and movable in an axial direction on the guide roll shafts.

At this time, the guide rolls may be composed of a first guide roll and a second guide roll, and the first and second guide rolls are vertically arranged by a predetermined interval.

As an alternative, the guide rolls may be composed of a first guide roll and a second guide roll, and the first and second guide rolls the fixed roll are arranged in a zigzag pattern.

In another case, the guide rolls may also be composed of a first guide roll, a second guide roll and a third guide roll, and the first, second and third guide rolls are vertically arranged.

As an alternative, the guide rolls may be composed of a first guide roll, a second guide roll and a third guide roll, and the first, second and third guide rolls and the fixed roll are arranged in a zigzag pattern.

### BRIEF DESCRIPTION OF THE DRAWINGS

FIG. 1 is a front view showing a fire detector installed to a ceiling of a building and including a fire detection unit and a lifting reel coupled with each other according to one embodiment of the present invention.

FIG. 2 is a front view showing that the fire detection unit of the fire detector according to one embodiment of the present invention is descended.

FIG. 3 is a front view showing an inner configuration of a fire detector having a lifting function, which also has a crime prevention function according to another embodiment of the present invention.

FIG. 4 is a side view showing the fire detector having lifting and crime prevention functions according to another embodiment of the present invention.

FIG. 5 is a front view showing a fire detection unit of the fire detector having lifting and crime prevention functions according to another embodiment of the present invention is descended.

FIG. 6 is a bottom view showing the fire detector having lifting and crime prevention functions according to another embodiment of the present invention.

FIG. 7 is a flowchart illustrating the crime prevention function of the fire detector having a lifting function according to another embodiment of the present invention.

FIG. 8 is a block diagram showing the crime prevention function of the fire detector having a lifting function according to another embodiment of the present invention.

FIG. 9 is a front view showing a fire detector according to still another embodiment of the present invention, in which a fire detection unit and a lifting reel are coupled with each other and installed to a ceiling of a building.

FIG. 10 is a front view showing that the fire detection unit of the fire detector according to still another embodiment of the present invention is descended.

FIG. 11 is a partially enlarged front view showing that contact terminals of the fire detector according to still another embodiment of the present invention are separated from each other.

FIG. 12 is a partially enlarged front view showing that a detection sensor according to still another embodiment of the present invention is turned on.

FIG. 13 is a partially enlarged front view showing that the detection sensor of the fire detector according to still another embodiment of the present invention is turned off.

FIG. 14 is a sectional view showing a fire detector having a lifting function according to another embodiment of the present invention.

FIG. 15 is a plane view and a bottom view showing contact terminals according to another embodiment of the present invention.

FIGS. 16 and 17 are plane view and bottom views showing modifications of the contact terminals according to another embodiment of the present invention.

FIG. 18 is a bottom view showing another modification of the contact terminal formed on a fixed body of the fire detector according to another embodiment of the present invention.

FIG. 19 is a plane view showing still another modification of the contact terminal formed on a lifting body of the fire detector according to another embodiment of the present invention.

FIG. 20 is a schematic view showing an inner configuration of a lifting reel according to one embodiment of the present invention.

FIG. 21 is a schematic view showing an inner configuration of a lifting reel according to another embodiment of the present invention.

FIG. 22 is a schematic view showing an inner configuration of a lifting reel according to still another embodiment of the present invention.

FIG. 23 is a schematic view showing an inner configuration of a lifting reel according to further another embodiment of the present invention.

FIG. 24 is a schematic view showing that a wire is guided by a plurality of guide rolls provided to the lifting reel of the fire detector according to the present invention.

### DESCRIPTION OF THE PREFERRED EMBODIMENT

Hereinafter, preferred embodiments of the present invention will be described in detail with reference to the accompanying drawings.

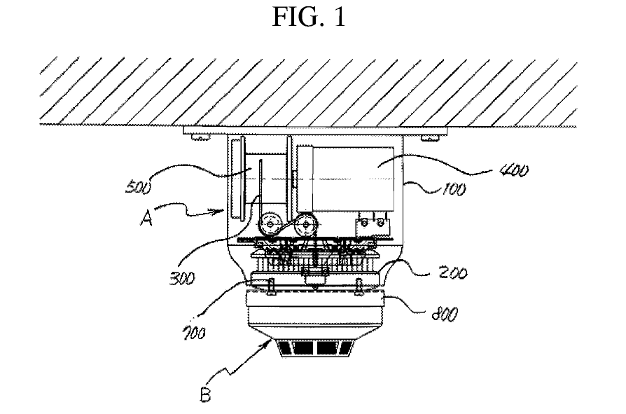

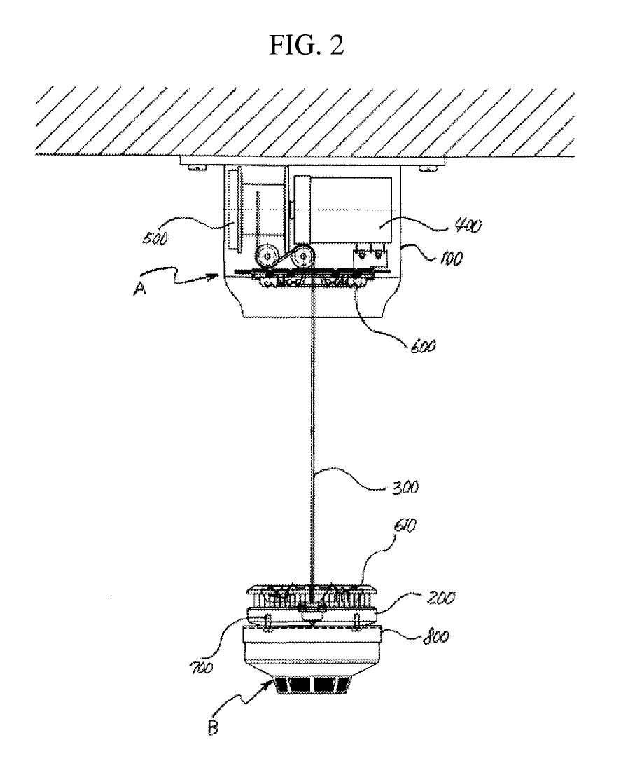

FIG. 1 is a front view showing a fire detection unit of a fire detector according to the present invention, which is installed to a ceiling of a building, and FIG. 2 is a front view showing that the fire detection unit of the fire detector according to the present invention is descended.

Referring to FIGS. 1 and 2, the fire detector according to the present invention includes a fixed body 100 fixed to the ceiling of a building, a lifting reel A installed to the fixed body 100 to move a wire 300 vertically below the fixed body 100, and a fire detection unit B connected to the wire 300 below the lifting reel A and installed to be vertically movable by the lifting reel A.

The lifting reel A includes a drum 500 connected to one end of the wire 300 to wind or unwind the wire 300 by a motor 400, a lifting body 200 positioned at a lower end of the fixed body 100 and connected to the other end of the wire 300, and a contact terminal 610 formed at an upper end of the lifting body 200. The contact terminal 610 of the lifting body 200 is connected to a contact terminal 600 formed at a lower end of the fixed body 100 when the lifting body 200 is completely ascended. In addition, the fire detection unit B is fixed to a lower portion of the lifting body 200.

In this configuration, the fire detection unit B is integrally formed at a lower end of the lifting body 200 of the lifting reel A, and it may be descended to the ground by the lifting reel A when the fire detection unit requires repair or exchange.

In addition, a socket 800 having a predetermined shape is formed at a lower end of the lifting body 200. The fire detection unit B is inserted into the socket 800 fixed to the lower end of the lifting body 200 by a coupling member 700. In this way, the fire detection unit B is electrically connected to the contact terminal 610 of the lifting body 200 through the socket 800.

For this purpose, the socket 800 is electrically connected to the contact terminal 610 formed at the upper end of the lifting body 200 by means of a lead wire or a terminal part before being fixed to the lower end of the lifting body 200 by the coupling member 700. Thus, if the fire detection unit B is inserted into the socket 800, the fire detection unit B is electrically connected to the contact terminal 610 by the socket 800. The contact terminal 610 is electrically connected to the contact terminal 600 formed at the lower end of the fixed body 100 when the fixed body 100 is coupled with the lifting body 200.

Here, the fire detection unit B is electrically connected to the lifting reel A using a well-known circuit, so it is not described in detail here. Also, the fire detection unit B employed in the present invention is not limited to a specific model, but it should be understood that various kinds of fire detection units B may be used if they may detect a fire.

Meanwhile, for making the fire detection unit B be lifted on the ceiling of a building, a separate lifting means, namely the lifting reel A using a wire, is required. The lifting reel A is installed to the fixed body 100 fixed to the ceiling of a building, and it is configured to move the fire detection unit B up and down.

Seeing the lifting reel A in brief, the lifting reel A includes the lifting body 200 that descends to the ground when a descend signal is input to a controller (not shown) positioned at a lower end of the fixed body 100 and ascends when an ascent signal is input. In addition, the lifting body 200 is connected to the wire 300, and the other end of the wire 300 is connected to the drum 500. The drum 500 is rotated by the motor 400 to wind or unwind the wire 300, thereby ascending or descending the lifting body 200. In addition, the contact terminals 600, 610 are respectively formed at the lower end of the fixed body 100 and the upper end of the lifting body 200, and the contact terminals 600, 610 are electrically connected with each other when the fixed body 100 is coupled with the lifting body 200.

In order to use the fire detector configured as above according to the present invention, the top of the fixed body 100 is firstly fixed to the ceiling of a building using bolts or hooks. Also, the fire detection unit B is integrally connected to the lower end of the lifting body 200.

In more detail, the socket 800 is formed at the lower end of the lifting body 200, and the socket 800 is coupled to the lower end of the lifting body 200 using the coupling member 700. At this time, the socket 800 is electrically connected to the contact terminal 610 formed at the upper end of the lifting body 200. After that, the fire detection unit B is inserted into the socket 800, and then the fire detection unit B is electrically connected to the contact terminal 610 through socket 800 and also integrally fixed to the lower end of the lifting body 200.

After that, the lifting reel A is installed to the fixed body 100 fixed to the ceiling of a building. Then, the fixed body 100 is coupled with the lifting body 200 while the fire detection unit B is connected to the lower end of the lifting body 200, as shown in FIG. 1. At this time, since the contact terminal 600 of the fixed body 100 is electrically connected with the contact terminal 610 of the lifting body 200, the fire detection unit B may detect a fire.

If a periodic repair or exchange is required while using the fire detection unit B in a normal state, a descend signal is input. Then, power is applied to the motor 400, rotating the drum 500. If the drum 500 rotates, the wire 300 wound around the drum 500 is unwound to descend the lifting body 200 as shown in FIG. 2. At this time, the fire detection unit B is also descended to the ground for convenience of a worker since the fire detection unit B is integrally connected to the lifting body 200. Also, the contact terminal 600 of the fixed body 100 and the contact terminal 610 of the lifting body 200 are separated from each other, so the power of the fire detection unit B is intercepted.

In this state, if the repair or exchange of the fire detection unit B is completed, an ascend signal is input to the lifting reel A. Then, the lifting body 200 is ascended and coupled with the fixed body 100. At this time, while the fixed body 100 is coupled with the lifting body 200, the contact terminal 600 of the fixed body 100 is electrically connected with the contact terminal 610 of the lifting body, and thus power is supplied to the fire detection unit B through the socket 800.

The fire detection unit B completely ascended as above is positioned on the ceiling of the building and conducts a normal fire detection function.

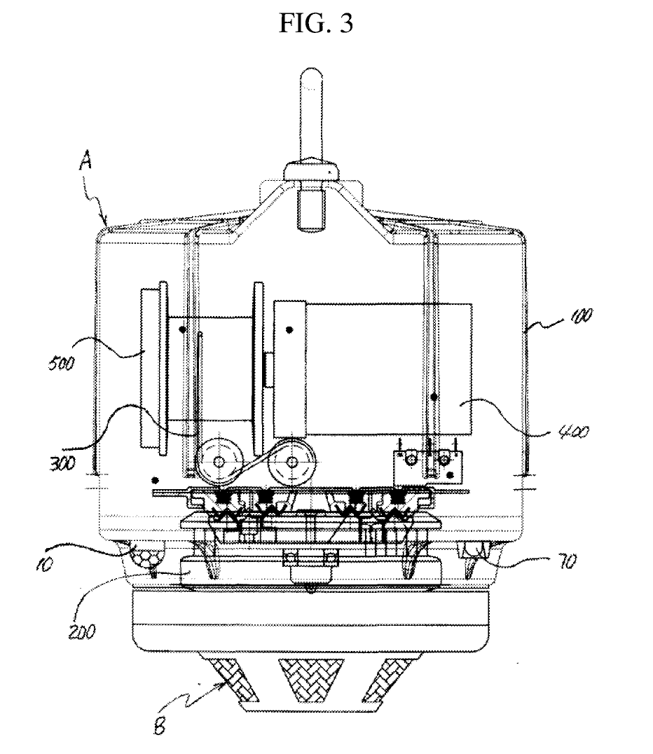

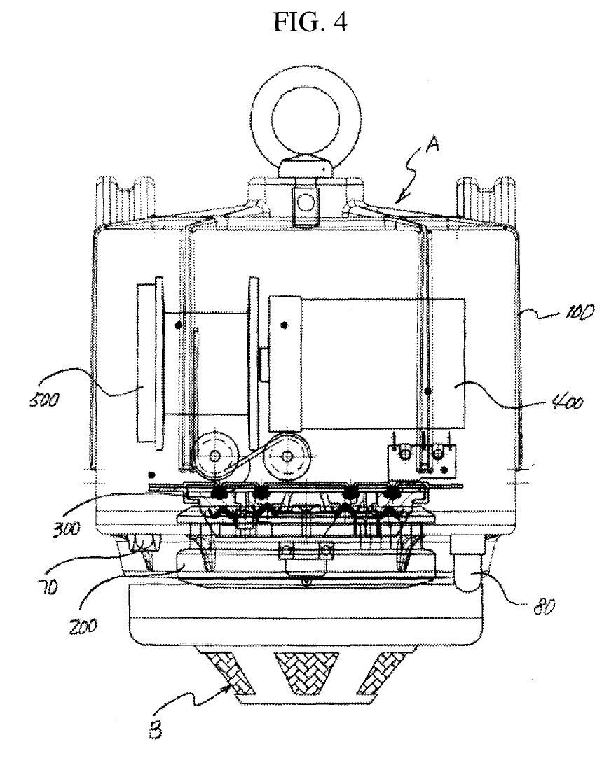

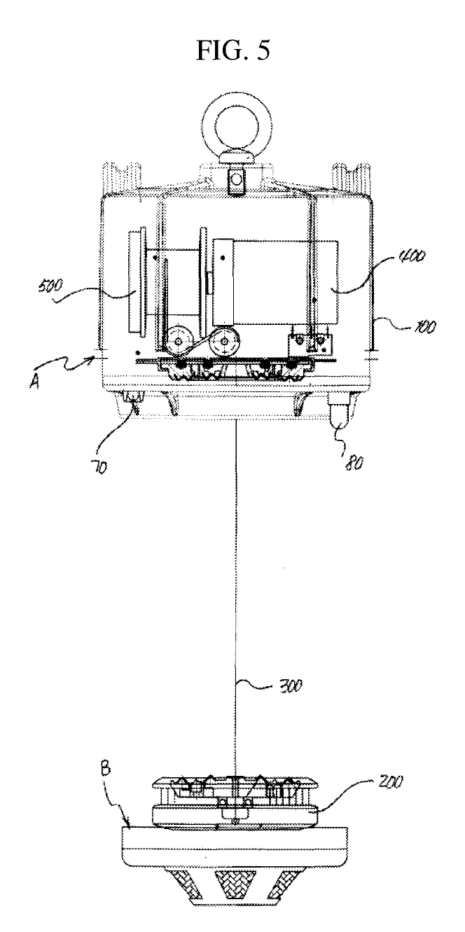

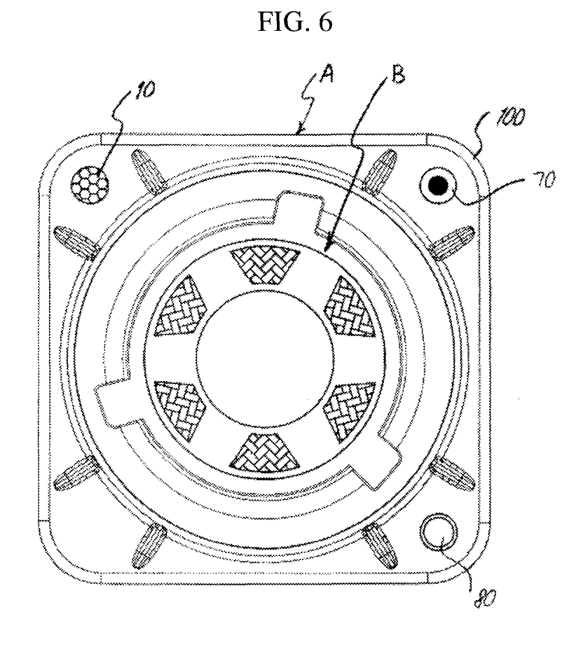

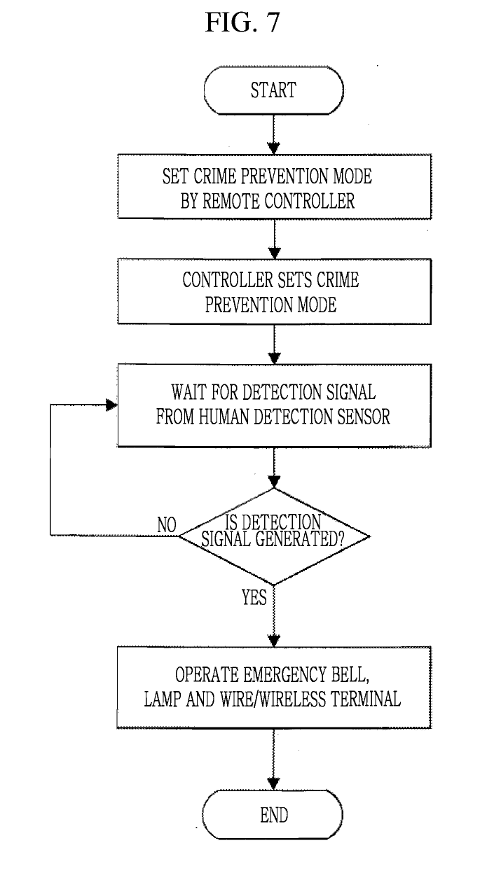

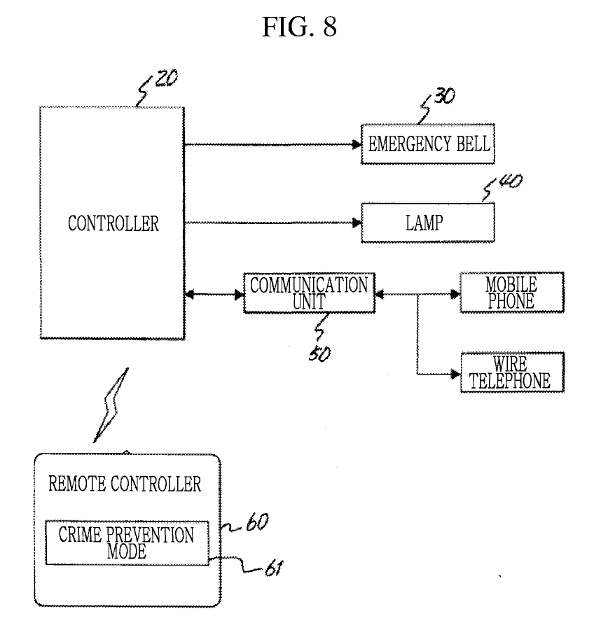

FIGS. 3 to 8 show a fire detector having a lifting function according to another embodiment of the present invention. The fire detector of this embodiment is substantially identical or similar to that of the former embodi8ment, except that it further includes a crime prevention unit that detects an alien illegally invading the building and informing a user of the fact.

First, referring to FIGS. 3 to 6, the crime prevention unit includes a human detection sensor 10 installed to a lower end of the fixed body 100 to detect an alien person illegally invading the building, an emergency bell 30 for generating an alarm to give an audible warning to a user in case the human detection sensor 10 detects an alien person illegally invading the building, a lamp 40 repeatedly turned on and off to give a visible warning to a user in case the human detection sensor 10 detects an alien person illegally invading the building, and a communication unit 50 for sending a warning message to a phone number set by a user using a wire/wireless communication network in case the human detection sensor 10 detects an alien person illegally invading the building.

In addition, the crime prevention unit may further include a remote controller 60 for wirelessly controlling all or some of components of the crime prevention unit, and a pilot lamp 70 used for checking from outside that the crime prevention unit is converted into a crime prevention mode by the remote controller 60.

In more detail, in this embodiment, as shown in FIGS. 3 to 6, the human detection sensor 10 is formed at the lower end of the fixed body 100, and the human detection sensor 10 detects an alien illegally invading a set area. If the human detection sensor 10 detects an alien illegally invading the set area, a controller 20 of the crime prevention unit informs a user of the fact in an audible or visual way or to a wire/wireless terminal.

The remote controller 60 makes wireless communication with the controller 20 and has a crime prevention button 61. If a user presses the crime prevention button 61, the controller 20 controls each component of the crime prevention unit and converts it into a crime prevention mode. At this time, the pilot lamp 70 installed at the lower end of the fixed body 10 is turned on to inform outside that the crime prevention unit is converted into a crime prevention mode.

Meanwhile, if the human detection sensor 10 detects an alien illegally invading a set area, the controller 20 operates the emergency bell 30 for generating an alarm to give an audible warning to the user, and repeatedly turns on and off the lamp 40 to give a visible warning to the user. Also, the controller 20 controls the communication unit 50 to send a warning message to a phone number set by the user through a wire/wireless communication network.

The controller 20 makes wireless communication with the remote controller 60 through a transceiver 80 formed on an outer portion of the fixed body 100. This controller 80 is programmed to have functions of converting into a crime prevention mode when a crime prevention mode signal is received from the remote controller 60, and functions of operating the emergency bell 30, the lamp 40 and the communication unit 50 when the human detection sensor 10 detects an alien illegally invaded in the crime prevention mode. In addition, the crime prevention mode 61 formed on the remote controller 60 is configured such the controller 20 is converted into a crime prevention mode when the crime prevention button 61 is pressed once, and the crime prevention mode is released when the crime prevention button 61 is pressed again.

The communication unit 50 has a function of automatically making a phone call to a designated phone number and then informing a user through a message.

The message may be a recorded or composed voice message or a text-based message. In case of a voice message, the message is sent to a personal voice message box of a user, while, in case of a text message, the message may be sent to a communication equipment of the user using SMS (Short Message Service) of a mobile communication network.

In order to use the crime prevention unit of the fire detector configured as above according to this embodiment, a user firstly presses the crime prevention button 61 formed on the remote controller 60. Then, this signal is received in the controller 20, and the crime prevention unit is converted into a crime prevention mode. At the same time, the controller 20 waits for a signal from the human detection sensor 10. Also, the pilot lamp 70 is turned on such that a user may check from outside that the controller 20 is converted.

If an alien invades a set area during the above crime prevention mode, the human detection sensor 10 instantly detects it, and the detection signal is transmitted to the controller 20. At this time, the controller 20 operates the emergency bell 30 to generate an alarm or turns on and off the lamp 40 such that the user may be informed the fact that an alien illegally invades the set area.

In addition, the controller 20 sends a warning message to a preset wireless terminal (or, a mobile phone) through the communication unit 50. Thus, though the user stays not indoor but outdoor, the user may check and deal with the fact that an alien illegally invades.

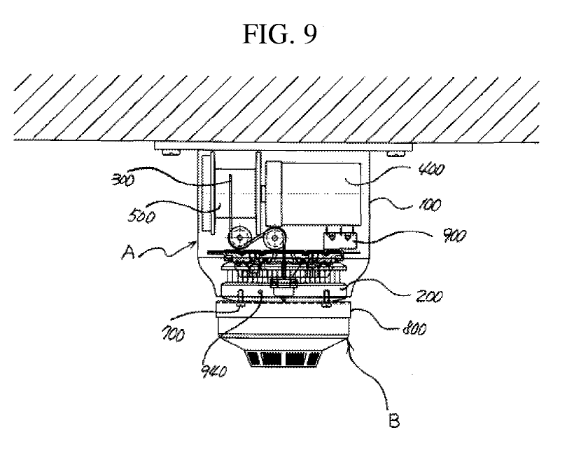

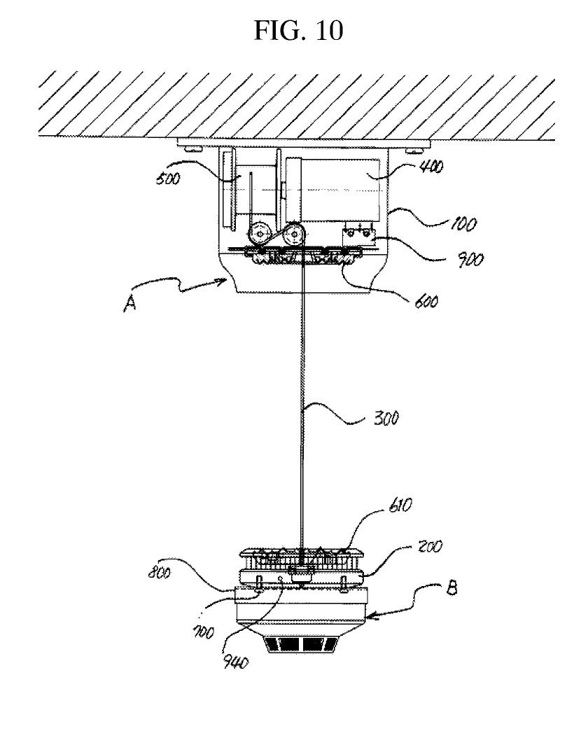

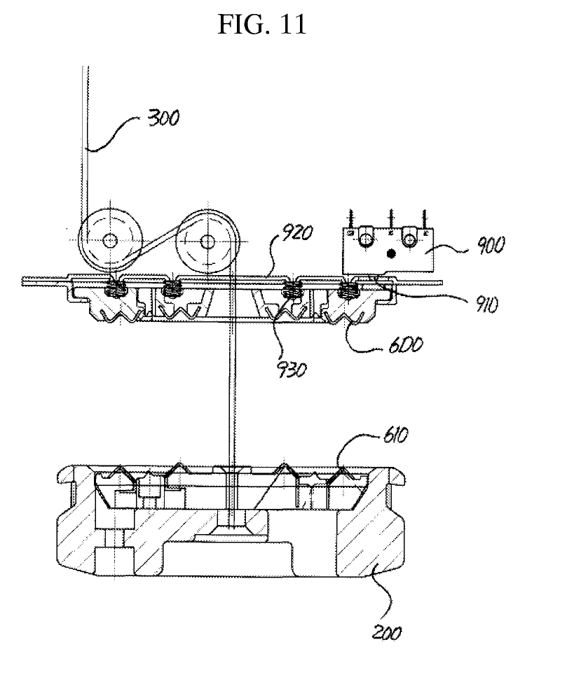

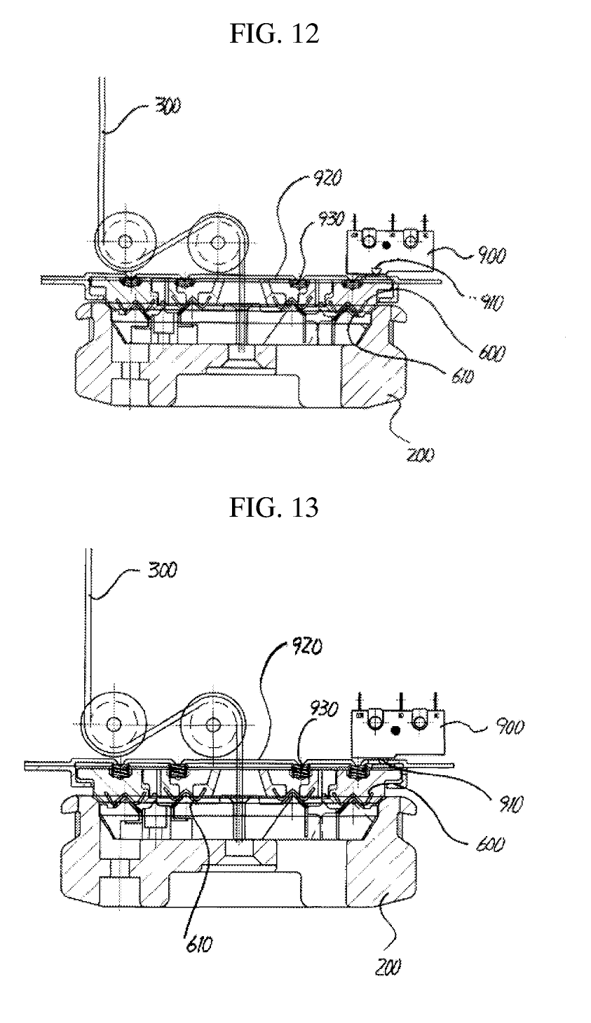

FIGS. 9 to 13 show a fire detector having a lifting function according to still another embodiment of the present invention. The fire detector of this embodiment is substantially similar to that of FIG. 1, except for configurations related to contact terminals.

That is to say, referring to FIGS. 9 to 13, the fire detector of this embodiment includes a fixed body 100 fixed to the ceiling of a building, a lifting reel A installed to the fixed body 100 to move a wire 300 up and down below the fixed body 100, and a fire detection unit B connected to the wire 300 below the lifting reel A and installed to be movable up and down by the lifting reel A.

The lifting reel A includes a drum 500 connected to one end of the wire 300 to wind or unwind the wire 300 by a motor 400, a lifting body 200 positioned at a lower end of the fixed body 100 and connected to the other end of the wire 300, and a contact terminal 610 formed at an upper end of the lifting body 200. The contact terminal 610 of the lifting body 200 is connected to a contact terminal 600 formed at a lower end of the fixed body 100 when the lifting body 200 is completely ascended. In addition, the fire detection unit B is fixed to a lower portion of the lifting body 200.

In this configuration, the fire detection unit B is integrally formed at a lower end of the lifting body 200 of the lifting reel A, and it may be descended to the ground by the lifting reel A when the fire detection unit requires repair or exchange.

In addition, a socket 800 having a predetermined shape is formed at a lower end of the lifting body 200. The fire detection unit B is inserted into the socket 800 fixed to the lower end of the lifting body 200 by a coupling member 700. In this way, the fire detection unit B is electrically connected to the contact terminal 610 of the lifting body 200 through the socket 800.

For this purpose, the socket 800 is electrically connected to the contact terminal 610 formed at the upper end of the lifting body 200 by means of a lead wire or a terminal part before being fixed to the lower end of the lifting body 200 by the coupling member 700. Thus, if the fire detection unit B is inserted into the socket 800, the fire detection unit B is electrically connected to the contact terminal 610 by the socket 800. The contact terminal 610 is electrically connected to the contact terminal 600 formed at the lower end of the fixed body 100 when the fixed body 100 is coupled with the lifting body 200.

Meanwhile, in this embodiment, a fixed plate 920 is installed above the contact terminal 600 of the fixed body 100. A spring 930 is installed between the contact terminal 600 of the fixed body 100 and the fixed plate 920 so as to elastically press the contact terminal 600 of the fixed body 100 downward. That is to say, in case the contact status of the contact terminals 600, 610 is loosed due to a loosed wire 300 or the like while the fire detector of this embodiment is used, the spring 930 presses the contact terminal 600 using its own elastic force such that the contact status between the contact terminals 600, 610 may be kept continuously.

A detection sensor 900 having a sensor touch unit 910 is installed to one side of an upper portion of the fixed plate 920. The detection sensor 900 is installed adjacent to the contact terminal 600 of the fixed body 100 to detect a contact status between the contact terminal 600 of the fixed body 100 and the contact terminal 610 of the lifting body 200.

At this time, while the lifting body 200 is ascended and closely attached to the fixed body 100, if the contact status between the contact terminal 600 of the fixed body 100 and the contact terminal 610 of the lifting body 200 is loosed, the motor 400 is driven to further ascend the lifting body 200, thereby continuously keeping the contact status between the contact terminals 600, 610.

In more detail, the sensor touch unit 910 is protruded out when the contact status between the contact terminals 600, 610 is loosed, thereby making the detection sensor 900 into an OFF state. On the while, if the contact terminals 600, 610 are closely adhered, the sensor touch unit 910 advances into the detection sensor 900 and makes the detection sensor 900 into an ON state.

The detection sensor 900 comes into an OFF state and operates the motor 400 if the contact status between the contact terminals 600, 610 is loosed, while the detection sensor 900 comes into an ON state and stops the motor 400 if the contact terminals 600, 610 are closely adhered.

Meanwhile, an LED 940 may be installed to the lifting body 200 in connection with the contact terminal 610 of the lifting body 200. The LED 940 is turned on when power is applied to the fire detection unit B, thereby displaying the operating state of the fire detection unit B to outside visibly. That is to say, a user may easily check by naked eyes whether power is supplied to the fire detection unit B or not, by means of the LED 940. That is to say, the LED 940 is used in electrically connection with the contact terminal 610. Thus, the user may determine that power is not applied to the fire detection unit B if the LED 940 is not turned on, while the user may determine that power is applied to the fire detection unit B if the LED 940 is turned on.

In order to use the fire detector configured as above according to the present invention, the top of the fixed body 100 is firstly fixed to the ceiling of a building using bolts or hooks. Also, the fire detection unit B is integrally connected to the lower end of the lifting body 200.

In more detail, the socket 800 is formed at the lower end of the lifting body 200, and the socket 800 is coupled to the lower end of the lifting body 200 using the coupling member 700. At this time, the socket 800 is electrically connected to the contact terminal 610 formed at the upper end of the lifting body 200. After that, the fire detection unit B is inserted into the socket 800, and then the fire detection unit B is electrically connected to the contact terminal 610 through socket 800 and also integrally fixed to the lower end of the lifting body 200.

After that, the lifting reel A is installed to the fixed body 100 fixed to the ceiling of a building. Then, the fixed body 100 is coupled with the lifting body 200 while the fire detection unit B is connected to the lower end of the lifting body 200, as shown in FIG. 1. At this time, since the contact terminal 600 of the fixed body 100 is electrically connected with the contact terminal 610 of the lifting body 200, the fire detection unit B may detect a fire.

If a periodic repair or exchange is required while using the fire detection unit B in a normal state, a descend signal is input. Then, power is applied to the motor 400, rotating the drum 500. If the drum 500 rotates, the wire 300 wound around the drum 500 is unwound to descend the lifting body 200 as shown in FIG. 2. At this time, the fire detection unit B is also descended to the ground for convenience of a worker since the fire detection unit B is integrally connected to the lifting body 200. Also, the contact terminal 600 of the fixed body 100 and the contact terminal 610 of the lifting body 200 are separated from each other, so the power of the fire detection unit B is intercepted.

In this state, if the repair or exchange of the fire detection unit B is completed, an ascend signal is input to the lifting reel A. Then, the lifting body 200 is ascended and coupled with the fixed body 100. At this time, while the fixed body 100 is coupled with the lifting body 200, the contact terminal 600 of the fixed body 100 is electrically connected with the contact terminal 610 of the lifting body, and thus power is supplied to the fire detection unit B through the socket 800.

The fire detection unit B completely ascended as above is positioned on the ceiling of the building and conducts a normal fire detection function.

In the above process, the fire detection unit B moving up and down by the lifting reel A experiences the following steps in order: supplying power to the fire detector->detecting a contact status of contact terminals->driving the motor->keeping contact of the contact terminals->closely adhering the contact terminals-<stopping the motor.

Step of Supplying Power to Fire Detection Unit

If the fixed body 100 fixed to the ceiling of a building is coupled with the lifting body 200 to which the fire detection unit B is connected at a lower end, the contact terminal 600 formed at the lower end of the fixed body 100 is closely adhered to the contact terminal 610 formed at the upper end of the lifting body 200, thereby supplying power to the fire detection unit B. At this time, the LED 940 is turned on.

Step of Detecting Contact Status Between Contact Terminals

If the contact terminals 600, 610 are closely adhered as mentioned above, the sensor touch unit 910 advances into the detection sensor 900 to always detect a contact status between the contact terminals 600, 610. In addition, the spring 930 disposed between the fixed plate 920 and the contact terminal 600 is compressed to continuously press the contact terminal 600 downward.

Step of Driving Motor

During the step of detecting a contact status of the contact terminals, if the wire 300 is loosed while the lifting reel A is used for a long time, the lifting body 200 is slightly descended, so the contact status between the contact terminals 600, 610 is loosed. At this time, if the contact status between the contact terminals 600, 610 is loosed, the sensor touch unit 910 is protruded out to give an OFF signal to the detection sensor 900, and the motor 400 is driven according to the OFF signal of the detection sensor 600.

Step of Keeping Contact Between Contact Terminals

During the step of driving the motor, though the contact status of the contact terminals 600, 610 is loosed, power should be always supplied to the fire detection unit B. thus, though an OFF signal is input to the detection sensor 900, the spring 930 elastically presses the contact terminal 600 formed at the lower end of the fixed body 100 toward the contact terminal 610 formed at the upper end of the lifting body 200, so the contact terminals 600, 610 keeps their contact status.

Step of Closely Adhering Contact Terminals

If the motor 400 is driven, the wire 300 is wound around the rotating drum 500. At this time, the lifting body 200 ascends to closely adhere the contact terminals 600, 610 to each other. If an On signal is input to the detection sensor 900 during the adhering process, the motor 400 stops.

Step of Stopping Motor

If an On signal is not input due to a malfunction of the detection sensor 900 or other exterior conditions during the step of adhering the contact terminals, the program determines that the detection sensor 900 is broken down, and then compulsorily stops the motor 400 after several seconds to prevent overheat of the motor.

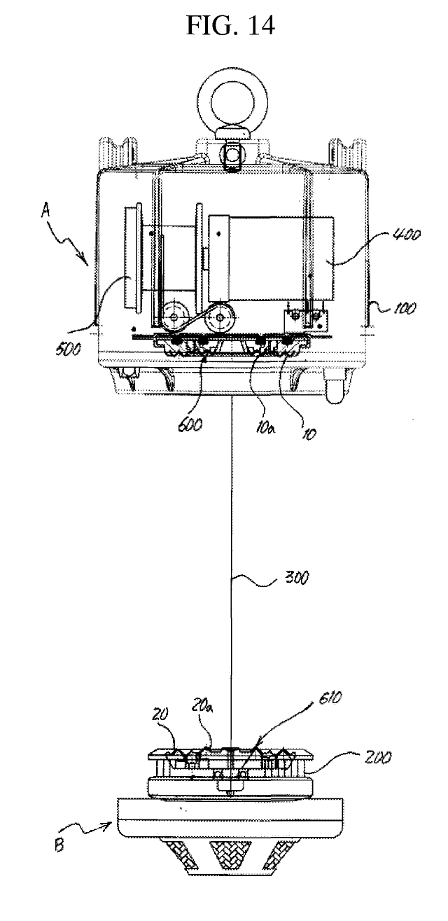

FIGS. 14 to 19 shows a fire detector having a lifting function according to further another embodiment of the present invention. The fire detector of this embodiment is substantially similar to those of former embodiments, except that shapes of the contact terminals formed on the fixed body and the lifting body are more specified.

That is to say, the contact terminal 600 formed at the lower end of the fixed body 100 is electrically connected to a power source, and the contact terminal 610 formed at the upper end of the lifting body 200 is electrically connected to the fire detection unit B. In addition, when the contact terminals 600, 610 are coupled with each other, power is applied to the fire detection unit B through a power line.

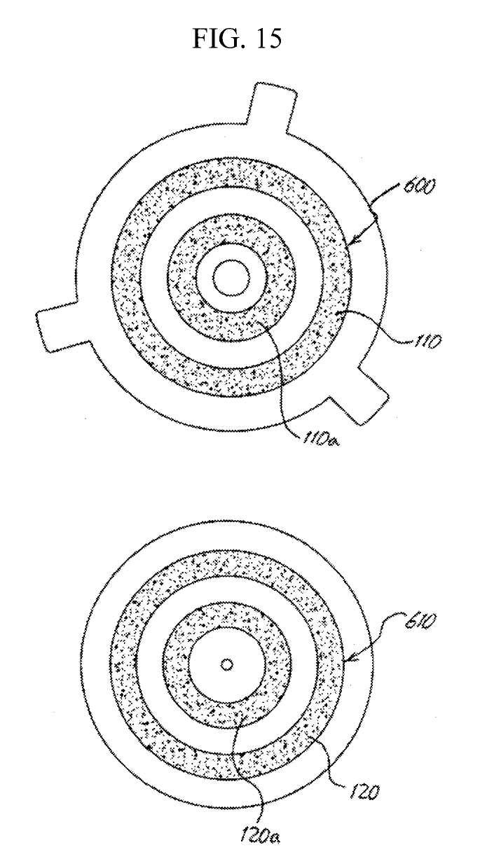

The contact terminal 600 formed at the lower end of the fixed body 100 is composed of a large outer circular terminal 110 and a small inner circular terminals 110a having concentric shapes with predetermined areas, and the contact terminals 610 formed at the upper end of the lifting body 200 is also composed of a large outer circular terminal 120 and a small inner circular terminal 120a having concentric shapes with predetermined areas, as shown in FIG. 15. At this time, the outer circular terminal 110 and the inner circular terminal 110a of the contact terminal 600 of the fixed body 100 have the same diameters as the outer circular terminal 120 and the inner circular terminal 120a of the contact terminal 610 of the lifting body 200. Thus, when the fixed body 100 is coupled with the lifting body 200, the outer circular terminals 110, 120 as well as the inner circular terminals 110a, 120a are surface-contacted with each other.

In order to use the fire detector configured as above according to this embodiment, first, the contact terminal 600 composed of the outer circular terminal 10 and the inner circular terminal 110a is installed to the lower end of the fixed body 100, and the contact terminal 610 composed of the outer circular terminal 120 and the inner circular terminal 120a is installed to the upper end of the lifting body 200, respectively. The contact terminals 600, 610 are positioned to correspond to each other.

In this state, if power is applied to the lifting reel A for periodic repair or exchange of the fire detection unit B, the motor 400 rotates the drum 500. Thus, the wire 300 wound around the rotating drum is unwound such that the lifting body 200 and the fire detection unit B integrally connected to each other are descended at the same time. At this time, the electric connection between the contact terminals 600, 610 is intercepted.

After the fire detection unit B is repaired or exchanged in a descended state, an ascent command is input to the lifting reel A such that the wire 300 is wound around the drum 500 to ascend the lifting body 200 and the fire detection unit B, contrarily to the above. At this time, while the lifting body 200 and the fire detection unit B is ascending, though the fire detection unit B is rotated right or left, the outer circular terminals 110, 120 and the inner circular terminals 110a, 120a may be electrically contacted in surface contact since they are formed in circular shapes.

Thus, since the contact terminal 600 formed at the lower end of the fixed body 100 and the contact terminal 610 formed at the upper end of the lifting body 200 are respectively composed of the outer circular terminals 110, 120 and the inner circular terminals 110a, 120a in ring shapes with predetermined areas in the above configuration, the contact terminals 600, 610 may be accurately electrically connected with each other by means of the outer circular terminals 110, 120 and the inner circular terminals 110a, 120a though the fire detection unit B is rotated right or left during the vertical movement.

Meanwhile, though it has been illustrated that the contact terminal 600 formed at the lower end of the fixed body 100 and the contact terminal 610 formed at the upper end of the lifting body 200 are respectively composed of the outer circular terminals 110, 120 and the inner circular terminals 110a, 120a in ring shapes, the present invention may be modified in various ways, not limited to the above.

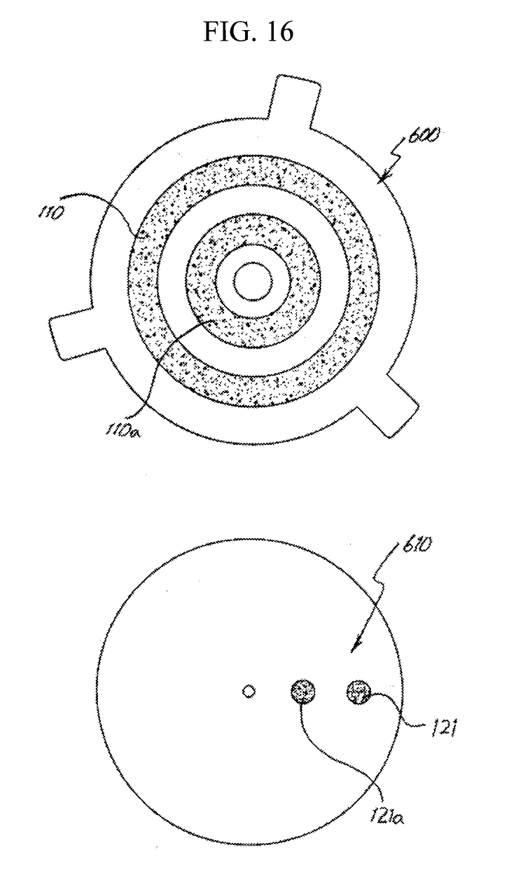

For example, as shown in FIG. 16, it is possible that the contact terminal 600 of the fixed body is composed of an outer circular terminal 110 and an inner circular terminal 110a having concentric shapes with predetermined areas, and the contact terminal 610 of the lifting body is composed of a small outer terminal 121 arranged in the same diameter as the outer circular terminal 110 of the contact terminal 600 of the body and a smaller inner terminal 121a arranged in the same diameter as the inner circular terminal 110a of the contact terminal 600 of the body.

As another alternative, the contact terminals 610 of the lifting body may not be composed of small outer terminal and small inner terminal, but any of them may be configured as a circular terminal.

For example, it is possible that the contact terminal 600 of the fixed body is composed of an outer circular terminal 110 and an inner circular terminal 110a having concentric shapes with predetermined areas as shown in FIG. 16, and the contact terminal 610 of the lifting body is composed of an outer circular terminal 120 arranged in the same diameter as the outer circular terminal 110 of the contact terminal 600 of the fixed body and having a predetermined area (see FIG. 15) and a small inner terminal 121a arranged in the same diameter as the inner circular terminal 110a of the contact terminal 600 of the fixed body.

As another example, it is also possible that the contact terminal 600 of the fixed body is composed of an outer circular terminal 110 and an inner circular terminal 110a having concentric shapes with predetermined areas as shown in FIG. 16, and the contact terminal 610 of the lifting body is composed of a small outer terminal 121 arranged in the same diameter as the outer circular terminal 110 of the contact terminal 600 of the fixed body and an inner circular terminal 120a arranged in the same diameter as the inner circular terminal 110a of the contact terminal 600 of the fixed body and having a predetermined area (see FIG. 15).

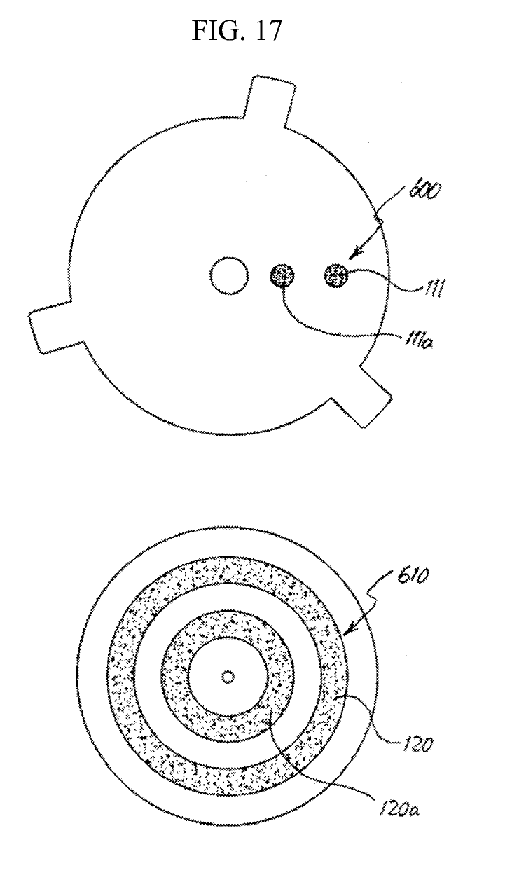

As still another alternative, as shown in FIG. 17, it is possible that the contact terminal 610 of the lifting body is composed of an outer circular terminal 120 and an inner circular terminal 120a having concentric shapes with predetermined areas, and the contact terminal 600 of the fixed body is composed of a small outer terminal 111 arranged in the same diameter as the outer circular terminal 120 of the contact terminal 610 of the lifting body and a small inner terminal 111a arranged in the same diameter as the inner circular terminal 120a of the contact terminal 610 of the lifting body.

Also, the contact terminal 600 of the fixed body may not be composed of small outer terminal and small inner terminal, but any of them may be configured as a circular terminal.

For example, it is possible that the contact terminal 610 of the lifting body is composed of an outer circular terminal 120 and an inner circular terminal 120a having concentric shapes with predetermined areas as shown in FIG. 17, and the contact terminal 600 of the fixed body is composed of an outer circular terminal 110 arranged in the same diameter as the outer circular terminal 120 of the contact terminal 610 of the lifting body and having a predetermined area (see FIG. 15) and a small inner terminal 111a arranged in the same diameter as the inner circular terminal 120a of the contact terminal 610 of the lifting body.

As another example, it is also possible that the contact terminal 610 of the lifting body is composed of an outer circular terminal 120 and an inner circular terminal 120a having concentric shapes with predetermined areas as shown in FIG. 17, and the contact terminal 600 of the fixed body is composed of a small outer terminal 111 arranged in the same diameter as the outer circular terminal 120 of the contact terminal 610 of the lifting body and an inner circular terminal 110a arranged in the same diameter as the inner circular terminal 120a of the contact terminal 610 of the lifting body and having a predetermined area (see FIG. 15).

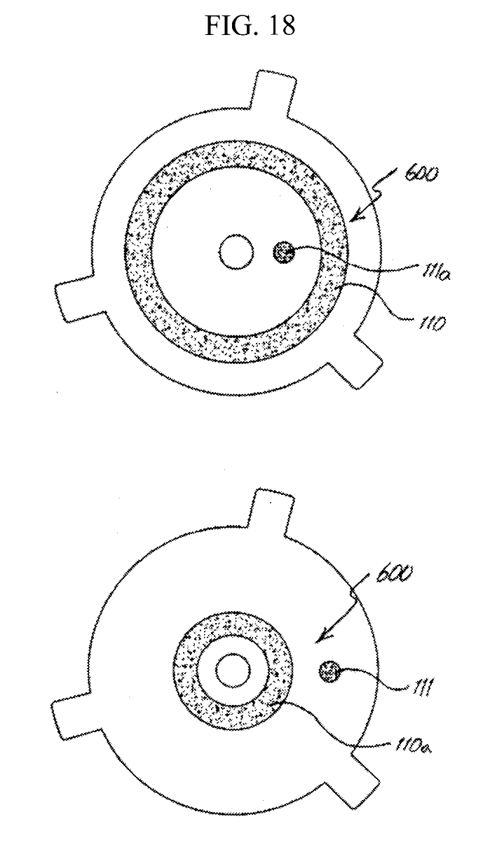

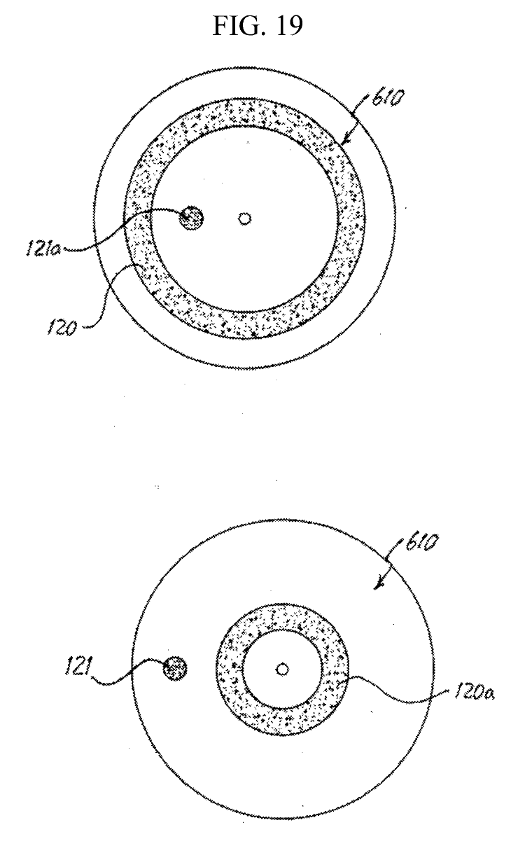

As still another alternative, as shown in an upper part of FIG. 18, the contact terminal 600 of the fixed body may be composed of an outer circular terminal 110 arranged in a predetermined diameter with a predetermined area, and a small inner terminal 111a arranged in the outer circular terminal 110. At this time, the contact terminal 610 of the lifting body is preferably composed of a small outer terminal 121 arranged in the same diameter as the outer circular terminal 110 of the contact terminal 600 of the fixed body and an inner circular terminal 120a arranged in the same diameter as the small inner terminal 111a of the contact terminal 600 of the fixed body and having a predetermined area, as shown in a lower part of FIG. 19.

As another example, as shown in an upper part of FIG. 19, the contact terminal of the lifting body may be composed of an outer circular terminal 120 arranged in a predetermined diameter with a predetermined area, and a small inner terminal 121a arranged in the outer circular terminal 120. At this time, the contact terminal 600 of the fixed body is preferably composed of a small outer terminal 111 arranged in the same diameter as the outer circular terminal 120 of the contact terminal 610 of the lifting body and an inner circular terminal 110a arranged in the same diameter as the small inner terminal 121a of the contact terminal 610 of the lifting body and having a predetermined area, as shown in a lower part of FIG. 18.

As explained above based on various examples, according to this embodiment, the outer circular terminals 110, 120 and the inner circular terminals 110a, 120a basically having predetermined areas may give the same effect though small outer terminals 111, 121 and small inner terminals 111a, 121a are used in combination.

Meanwhile, the lifting reel of the fire detector according to the present invention may have a plurality of guide rolls therein such that the wire may be more uniformly wound around the drum, as explained below.

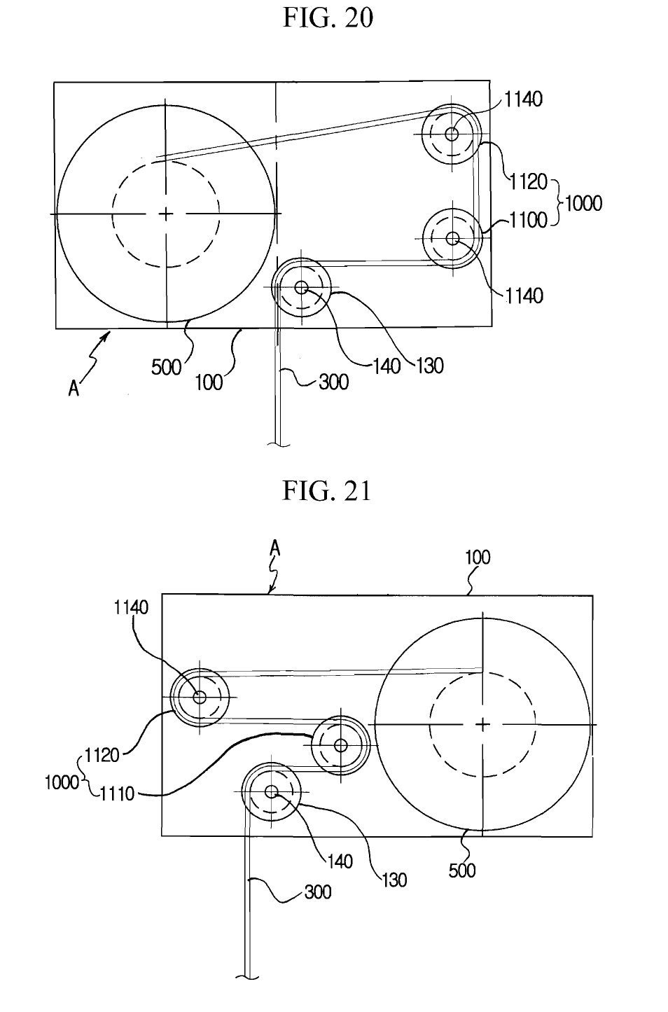

FIG. 20 is a schematic view showing an inner configuration of a lifting reel according to one embodiment of the present invention. Referring to FIG. 20, the lifting reel A of this embodiment includes a fixed body 100 fixed to the ceiling of a building, a drum 500 arranged in the fixed body 100 and rotated in a clockwise/counterclockwise direction by a motor 400 (see FIG. 1), a wire 300 having one end fixed to the drum 500 and the other end connected to the fire detection unit B (see FIG. 1) and wound/unwound around the drum 500, a fixed roll 130 keeping a predetermined space from the drum 500 and rotated on a fixed roll shaft 140 to guide the wire 300 while the wire 300 taken-up around the drum 500 is wound or unwound, and a plurality of guide rolls 1000 arranged between the drum 500 and the fixed roll 130.

In the lifting reel A of this embodiment, when the wire 300 is wound around the drum 500, the plurality of guide rolls 1000 arranged between the drum 500 and the fixed roll 130 make the wire 300 be wound uniformly on the entire outer circumference of the drum 500 with keeping substantially perpendicular to the drum 500.

In this embodiment, two or three guide rolls 1000 are preferably arranged between the drum 500 and the fixed roll 130. The guide rolls 1000 are rotatably coupled to guide roll shafts 1140, to be movable axially on the guide roll shafts 1140, respectively.

In case one guide roll is arranged between the drum and the fixed roll, a wire may be mostly wound around the center of the drum since the guide roll may not guide the wire to both side ends of the drum. However, in this embodiment, the plurality of guide rolls 1000 guide the wire 300 in a wider range, so the wire 300 is more naturally wound around the entire outer circumference of the drum 500 uniformly. Meanwhile, in case more than three guide rolls are arranged, a production cost may be increased due to an increased size or complicated configuration of the lifting reel.

Referring to FIG. 20 again, the guide rolls 1000 of this embodiment include a first guide roll 1110 and a second guide roll 1120. The first guide roll 1110 and the second guide roll 1120 are arranged vertically with a predetermined interval. In this state, when the wire 300 is taken-up around the drum 500, the wire 300 is wound on the drum 500 with passing over the fixed roll 130, the first guide roll 1110 and the second guide roll 1120 in order. At this time, the first guide roll 1110 moves just a little in an axial direction based on the center of the drum 500, but the second guide roll 1120 guides the wire 300 with moving to both side ends of the drum 500 on the guide roll shaft 1140. Thus, the wire 300 is uniformly wound on the drum 500 with keeping a substantially perpendicular state to the drum 500.

Meanwhile, the first guide roll 1110 and the second guide roll 1120 are not limited to the above vertical arrangement, but they may be arranged in different ways if they may guide the wire 300 to both side ends of the drum 500. For example, the first guide roll 1110 and the second guide roll 1120 may be arranged in a zigzag pattern as shown in FIG. 21.

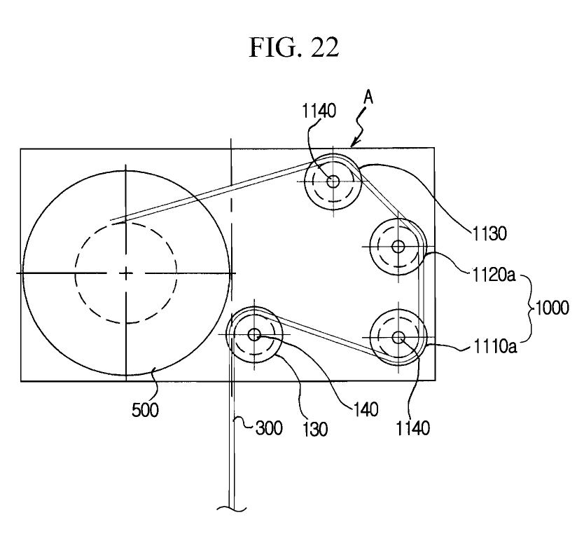

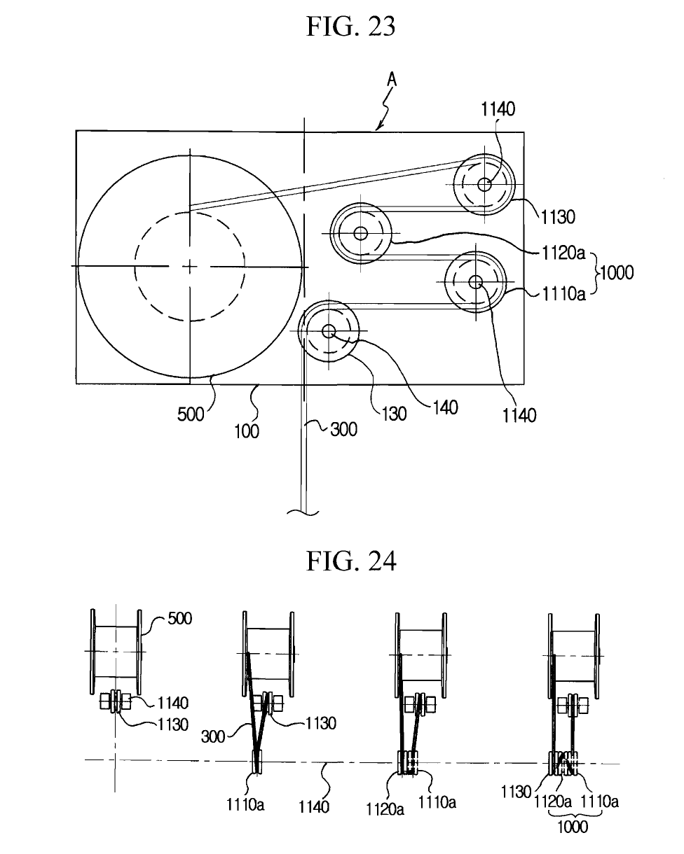

FIG. 22 shows another example that the lifting reel A has three guide rolls. In this embodiment, the guide rolls 1000 are composed of a first guide roll 1110a, a second guide roll 1120a and a third guide roll 1130, and the first, second and third guide rolls 1110a, 1120a, 1130 are arranged vertically. These first, second and third guide rolls 1110a, 1120a, 1130 are not limited to the vertical arrangement, but the first, second and third guide rolls 1110a, 1120a, 1130 may also be arranged in a zigzag pattern on occasions as shown in FIG. 23, if they may guide the wire 300 to both side ends of the drum 500.

In case three guide rolls 1110 are configured as mentioned above, the wire 300 may be more precisely guided to both side ends of the drum 500 using the first, second and third guide rolls 1110a, 1120a, 1130 arranged vertically or in a zigzag pattern between the drum 500 and the fixed roll 130.

That is to say, as shown in FIG. 24, the wire 300 is wound around the drum 500 with passing over the first, second and third guide rolls 1110a, 1120a, 1130, arranged between the drum 500 and the fixed roll 130, in order. At this time, the first guide roll 1110a guides the wire 300 with moving a little in an axial direction based on the center of the drum 500, the second guide roll 1120a guides the wire 300 more outwardly than the first guide roll, and the third guide roll 1130 guides the wire 300 to both side ends of the drum 500, so the wire 300 is wound on the drum 500 to both side ends of the drum 500 with being kept substantially perpendicular to the drum 500.

### APPLICABILITY TO THE INDUSTRY

As explained above, according to the present invention, a lifting reel is separately installed to a fire detector fixed to the ceiling of a building to detect heat or smoke and prevent a fire.

Thus, it is possible to descend the fire detector to the ground using the lifting reel such that the fire detector may be periodically or frequently maintained or exchanged safely on the ground, so the fire detector may always detect a fire and accordingly reduce any life and fortune damages.

In addition, the fire detector of the present invention is provided with a crime prevention unit to advantageously detect an alien illegally invading into a building using a human detection sensor installed to a lower end of the fixed body and then informing a user of the fact in an audible or visible way or using a wire/wireless terminal.

In addition, if a contact status of contact terminals used for applying power to the fire detection unit is loosed, the fire detector of the present invention closely adheres both contact terminals such that the fire detection unit is always supplied with power.

In addition, a user may determine by naked eyes using the LED formed on the lifting body whether power is supplied to the fire detection unit, so the user may deal with any situation if power supplied to the fire detection unit is intercepted.

In addition, since the contact terminals formed at a lower end of the fixed body and an upper end of the lifting body are respectively composed of inner circular terminal and outer circular terminal having predetermined areas, the fire detector of the present invention may stably connect both contact terminal in a surface contact manner.

Thus, when the fixed body and the fire detection unit are coupled with each other, the contact terminals formed at the lower end of the fixed body and the upper end of the lifting body may be accurately electrically connected by means of the inner circular terminals and the outer circular terminals.

In addition, the lifting reel of the fire detector according to the present invention winds a wire connected to a moving unit around a drum via the plurality of guide rolls arranged in the lifting reel so the wire is guided to both side ends of the drum by means of the guide rolls and thus uniformly wound around the outer circumference of the drum.

In addition, the fire detector according to the present invention may be designed in a smaller size since the wire may be uniformly taken up around the drum by means of the plurality of guide rolls without increasing an outer diameter of the drum or increasing a distance between the drum and the guide rolls. Also, the lifting reel according to the present invention may easily take up a large amount of wire around the drum, so the lifting reel may be installed to the ceiling at a great height.

What is claimed is:

1. A fire detector having a lifting function, comprising:
a fixed body fixed to a ceiling of a building;
a lifting reel installed to the fixed body to vertically move a wire below the fixed body; and
a fire detection unit connected to the wire below the lifting reel and installed to be vertically movable by the lifting reel.

2. The fire detector having a lifting function according to claim 1, wherein the lifting reel includes:
a drum connected with one end of the wire and capable of winding or unwinding the wire by a motor;
a lifting body positioned at a lower end of the fixed body and connected with the other end of the wire; and
a contact terminal formed at an upper end of the lifting body,
wherein the contact terminal of the lifting body is contacted with a contact terminal formed at a lower end of the fixed body when the lifting body is completely ascended,
wherein the fire detection unit is fixed to a lower portion of the lifting body.

3. The fire detector having a lifting function according to claim 2,
wherein a socket is formed at a lower end of the lifting body, and
wherein the fire detection unit is electrically connected to the contact terminal of the lifting body through the socket when being fixed to the lifting body.

4. The fire detector having a lifting function according to claim 1, further comprising:
a crime prevention unit installed to the fixed body to detect an alien person illegally invading the building and informing a user of the fact.

5. The fire detector having a lifting function according to claim 4, wherein the crime prevention unit includes:
a human detection sensor installed to a lower end of the fixed body to detect an alien person illegally invading the building;
an emergency bell for generating an alarm to give an audible warning to a user in case the human detection sensor detects an alien person illegally invading the building;
a lamp repeatedly turned on and off to give a visible warning to a user in case the human detection sensor detects an alien person illegally invading the building; and
a communication unit for sending a warning message to a phone number set by a user using a wire/wireless communication network in case the human detection sensor detects an alien person illegally invading the building.

6. The fire detector having a lifting function according to claim 5, wherein the crime prevention unit further includes:
a remote controller for wirelessly manipulating all or some components of the crime prevention unit; and
a pilot lamp used for checking from outside that the crime prevention unit is converted into a crime prevention mode by the remote controller.

7. The fire detector having a lifting function according to claim 2,
wherein a fixed plate is installed on the contact terminal of the fixed body, and a spring is installed between the contact terminal of the fixed body and the fixed plate to elastically press the contact terminal of the fixed body downward.

8. The fire detector having a lifting function according to claim 2, further comprising:
a detection sensor installed adjacent to the contact terminal of the fixed body to detect a contact status between the contact terminal of the fixed body and the contact terminal of the lifting body,
wherein, while the lifting body is ascended and contacted with the fixed body, in case the contact status between the contact terminal of the fixed body and the contact terminal of the lifting body is loosed, the motor is driven to additionally ascend the lifting body.

9. The fire detector having a lifting function according to claim 8, further comprising:
an LED (Light Emitting Diode) installed to the lifting body in connection with the contact terminal of the lifting body,
wherein the LED is turned on when power is applied to the fire detection unit, thereby visibly displaying to outside whether the fire detection unit is operating.

10. The fire detector having a lifting function according to claim 2,
wherein the contact terminal of the fixed body is composed of an outer circular terminal and an inner circular terminal, which have concentric shapes with predetermined areas, and
wherein the contact terminal of the lifting body is composed of an outer circular terminal and an inner circular terminal, which have concentric shapes with predetermined areas and are disposed in the same diameter as the contact terminal of the fixed body.

11. The fire detector having a lifting function according to claim 2,
wherein the contact terminal of the fixed body is composed of an outer circular terminal and an inner circular terminal, which have concentric shapes with predetermined areas, and
wherein the contact terminal of the lifting body is composed of an outer circular terminal disposed in the same diameter as the outer circular terminal of the contact terminal of the fixed body having a predetermined area and a small inner terminal disposed in the same diameter as the inner circular terminal of the fixed body.

12. The fire detector having a lifting function according to claim 2,
wherein the contact terminal of the fixed body is composed of an outer circular terminal and an inner circular terminal, which have concentric shapes with predetermined areas, and
wherein the contact terminal of the lifting body is composed of a small outer terminal disposed in the same diameter as the outer circular terminal of the contact terminal of the fixed body and an inner circular terminal disposed in the same diameter as the inner circular terminal of the fixed body and having a predetermined area.

13. The fire detector having a lifting function according to claim 2,
wherein the contact terminal of the fixed body is composed of an outer circular terminal and an inner circular terminal, which have concentric shapes with predetermined areas, and
wherein the contact terminal of the lifting body is composed of a small outer terminal disposed in the same diameter as the outer circular terminal of the contact terminal of the fixed body and a small inner terminal disposed in the same diameter as the inner circular terminal of the fixed body.

14. The fire detector having a lifting function according to claim 2,
wherein the contact terminal of the lifting body is composed of an outer circular terminal and an inner circular terminal, which have concentric shapes with predetermined areas, and
wherein the contact terminal of the fixed body is composed of an outer circular terminal disposed in the same diameter as the outer circular terminal of the contact terminal of the lifting body having a predetermined area and a small inner terminal disposed in the same diameter as the inner circular terminal of the lifting body.

15. The fire detector having a lifting function according to claim 2,
wherein the contact terminal of the lifting body is composed of an outer circular terminal and an inner circular terminal, which have concentric shapes with predetermined areas, and
wherein the contact terminal of the fixed body is composed of a small outer terminal disposed in the same diameter as the outer circular terminal of the contact terminal of the lifting body and an inner circular terminal disposed in the same diameter as the inner circular terminal of the lifting body and having a predetermined area.

16. The fire detector having a lifting function according to claim 2,
wherein the contact terminal of the lifting body is composed of an outer circular terminal and an inner circular terminal, which have concentric shapes with predetermined areas, and
wherein the contact terminal of the fixed body is composed of a small outer terminal disposed in the same diameter as the outer circular terminal of the contact terminal of the lifting body and a small inner terminal disposed in the same diameter as the inner circular terminal of the lifting body.

17. The fire detector having a lifting function according to claim 2,
wherein the contact terminal of the fixed body is composed of an outer circular terminal disposed in a predetermined diameter and having a predetermined area and a small inner terminal disposed in the outer circular terminal, and
wherein the contact terminal of the lifting body is composed of a small outer terminal disposed in the same diameter as the outer circular terminal of the contact terminal of the fixed body and an inner circular terminal disposed in the same diameter as the small inner terminal of the fixed body and having a predetermined area.

18. The fire detector having a lifting function according to claim 2,
wherein the contact terminal of the lifting body is composed of an outer circular terminal disposed in a predetermined diameter and having a predetermined area and a small inner terminal disposed in the outer circular terminal, and
wherein the contact terminal of the fixed body is composed of a small outer terminal disposed in the same diameter as the outer circular terminal of the contact terminal of the lifting body and an inner circular terminal disposed in the same diameter as the small inner terminal of the lifting body and having a predetermined area.

19. The fire detector according to claim 1, wherein the lifting reel includes:
a drum rotated by a motor in a clockwise/counterclockwise direction;
a wire connected to the fire detection unit with one end being fixed to the drum so as to be wound or unwound around the drum;
a fixed roll spaced apart from the drum by a predetermined distance and rotated on a fixed roll shaft to guide the wire while the wire taken-up around the drum is wound or unwound; and
at least two guide rolls arranged between the drum and the fixed roll to guide the wire,
wherein the at least two guide rolls guide the wire substantially perpendicular to the drum while the wire is wound around the drum.

20. The fire detector according to claim 19,
wherein two or three guide rolls are arranged between the drum and the fixed roll, and the guide rolls are rotatably coupled to guide roll shafts respectively and movable in an axial direction on the guide roll shafts.

21. The fire detector according to claim 20,
wherein the guide rolls are composed of a first guide roll and a second guide roll, and the first and second guide rolls are vertically arranged by a predetermined interval.

22. The fire detector according to claim 20,
wherein the guide rolls are composed of a first guide roll and a second guide roll, and the first and second guide rolls the fixed roll are arranged in a zigzag pattern.

23. The fire detector according to claim 20,
wherein the guide rolls are composed of a first guide roll, a second guide roll and a third guide roll, and the first, second and third guide rolls are vertically arranged.

24. The fire detector according to claim 20,
wherein the guide rolls are composed of a first guide roll, a second guide roll and a third guide roll, and the first, second and third guide rolls and the fixed roll are arranged in a zigzag pattern.
